(19) United States
(12) Patent Application Publication
(10) Pub. No.: US 2008/0005922 A1
(43) Pub. Date: Jan. 10, 2008

(54) Cereals-Drying Method and Drying Device Using Such Drying Method

(75) Inventors: Masayoshi Kurashima, Gunma (JP); Isao Kishinami, Gunma (JP)

Correspondence Address: OBLON, SPIVAK, MCCLELLAND MAIER & NEUSTADT, P.C., 1940 DUKE STREET, ALEXANDRIA, VA, 22314, US

(73) Assignee: SAPPORO BREWERIES LIMITED, TOKYO (JP)

(21) Appl. No.: 11/628,711

(22) PCT Filed: Jun. 7, 2005
(86) PCT No.: PCT/JP05/10425

§ 371 Date: Sep. 18, 2007

(30) Foreign Application Priority Data
Jun. 8, 2004 (JP) 2004-170059

(51) Int. Cl. F26B 17/00

(52) U.S. Cl. 34/236

(57) ABSTRACT

The present invention discloses a drying apparatus which enables uniform drying of grain. The drying apparatus has diffusion means which spread the grain accumulated on the floor into a layer, and the diffusion means has a screw conveyer which rotates around a rotatable shaft. A plow member is provided, which penetrates inside the layer of grain accumulated along the screw conveyer and disturbs the grain. The grain which is supplied in the drying chamber is spread at a uniform layer depth and uniform diffusion density by the screw conveyer and the plow member. The whole grain family can be dried equalized by heated air blowing from a heat wind blower.

### BACKGROUND OF THE INVENTION

1. Field of the Invention

This invention generally relates to a drying apparatus for drying grain like rice, wheat, and barley and malt (hereinafter, grain family), and more particularly to the drying apparatus which provides uniform density of a layer for drying grain and malt which should be dried and which are uniformly spread and stacked to a predetermined depth on a bottom surface of the drying apparatus.

2. Description of the Related Art

As a conventional drying apparatus for drying grain like rice, wheat, and barley and malt, as shown in FIGS. 1 and 2, as an example, a bottom surface (halftone plate) 2 through which it is possible for air to flow in a cylindrical drying chamber 1 in the apparatus, and diffusion means 4 for forming a layer of grain 3 with a predetermined depth on the bottom surface 2 are provided. The diffusion means 4 has a rotatable shaft 5 at the center of the cylindrical drying chamber 1 as shown in FIG. 1, and a screw conveyer 6 which rotates in the cylindrical drying chamber is provided with one end at the center of the rotatable shaft 5. A grain inlet 9 is provided on the upper surface of the cylindrical drying chamber 1. The grain 3 which should be dried is supplied from this inlet 9 to the bottom surface 2 around the central region of the cylindrical drying chamber 1, then the grain 3 is moved on the bottom surface 2 sequentially from the central region of the cylindrical drying chamber 1 to inner walls of the cylindrical drying chamber 1 and a layer having a predetermined depth is formed by spreading the grain all over the bottom surface 2. Next, heated wind (air flow) is supplied into the cylindrical drying chamber 1 from a heated wind blower 8 provided on an outer wall 7 of the cylindrical drying chamber 1. The heated wind passes the grain layer 3 and the bottom surface 2 then the heated wind exits by flowing under the bottom surface 2. The grain 3 can be dried by the flow of this heated wind.

The screw conveyer 6 is also provided for up-down and rotatable movement via two support shafts 11, 12 and elevator devices 13, 14 supporting the support shafts 11 and 12, respectively. The rotatable shaft 5 is provided in a rotation driving device 15 mounted at the center of a circular ceiling 13 of the cylindrical drying chamber 1. Also, the rotatable shaft 5 hangs pivotally downward from the ceiling 13 and the central support shaft 12 is fixed at a lowest end of the rotatable shaft 5. An arm 16 which runs in a radial direction is provided on the elevator device 14 at the lower end of the rotatable shaft 5, a tip of the arm 16 is connected to the elevator device 13 provided on the upper end of the support shaft 11, and the elevator device 13 is connected to a movable shaft 18 supported, in which the upper end of the elevator device 13 is coupled with a supported movable shaft 18 on the ceiling 13 by wheels 17, 17. Also, the lower ends of support shafts 11 and 12 are fixed to the screw conveyer 6. In support shafts 11, 12, those upper parts are accommodated in the movable shaft 18 and the rotatable shaft 5 with elevator devices 13 and 14, respectively, and the screw conveyer 6 is moved in the up-and-down directions by the up-and-down motion of these support shafts 11 and 12.

Also, the arm 16 provided on the rotatable shaft 5 is rotated by the rotation of the rotatable shaft 5; thereby, the screw conveyer 6 is rotated around the support shaft 12 side via the support shaft 11 connected though the elevator device 13 with the tip of the support shaft 11. The inner wall of the drying chamber of the screw conveyer 6 is moved on a circular rail 19 which is installed on the bottom floor around the rotatable shaft 5.

Also, a device which drives the screw 20 which drives the screw conveyer 6 rotationally is provided on the end of the screw conveyer 6, and the grain which is accumulated on the bottom surface 2 is moved into the periphery from the central region of the drying chamber by rotating the screw conveyer 6.

### SUMMARY OF THE INVENTION

On the other hand, the grain which is spent (discharged) in the central region from the screw conveyer 6 becomes a uniform depth on the floor, thereby it appears that the grain layer formed on the drying chamber floor is a layer where density of the grain is uniform in the appearance inside the layer. However, it is recognized that density is high in the vicinity of an approximately central rotatable shaft 12 of the drying chamber 1 which is a place where the grain is supplied, and the lowest density is in the periphery spaced apart from the central region, as a result of investigation of an inventor of the present invention. Therefore, meaningful variation occurs in the passage of the heated wind supplied for drying. As a result, the degree of drying of the grain is different depending on places of the drying chamber, and the drying is unbalanced.

The present invention may provide a drying apparatus for the grain having the diffusion means which makes the grain spent on the drying chamber floor in the shape of layer. Especially, the drying apparatus for the grain and a drying method in which variation of density of the grain considered to be in the shape of the layer is eliminated, and thereby, the grain can be dried uniformly.

Accordingly, there is provided according to one aspect of the present invention a drying apparatus for the grain family comprising:

a drying chamber having a floor where the circulation of air is possible,

wind feed means to supply dry wind in the drying chamber,

feed means to supply the grain family which should be dried in a predetermined position on the floor,

diffusion means to spread the grain family supplied by the drying chamber in a layer so that the grain is uniform in depth on the floor, and

plow means which moves with transfer by the diffusion means and plows the layer of the grain family formed by the diffusion means.

There is also provided according to another aspect of the present invention a drying method of the grain family, where grain that should be dried is layered to a predetermined depth on a floor of a drying chamber, and the grain or malt is dried by supplying a dry wind and circulating the dry wind in the layer, wherein density of the layer of grain is equalized by spreading the grain on the floor in a layer and also plowing the layer of the grain.

According to an embodiment of the present invention, the grain family spent on the drying chamber floor of the drying apparatus is in the shape of a layer with a uniform depth formed by the diffusion means, and the variation of density can be eliminated by plowing with the plowing means in the layer of the grain. By doing so, the grain can be dried uniformly.

### BRIEF DESCRIPTION OF THE DRAWINGS

Other objects, features and advantages of the present invention will become more apparent from the following detailed description when read in conjunction with-the accompanying drawings, in which:

FIG. 1 is a figure showing a conventional drying apparatus;

FIG. 2 is a cross-sectional view of A-A section of FIG. 1;

FIG. 3 is a figure showing an example of the drying apparatus of the present invention;

FIG. 4 is a cross-sectional view of B-B section of FIG. 3;

FIG. 5 is a figure showing a plow member in detail; and

FIG. 6 are graphs showing results of examples, in which (a) is a graph in the case of using the conventional apparatus and (b) is a graph in the case of using the apparatus of the present invention.

### DESCRIPTION OF THE PREFERRED EMBODIMENTS

A description will now be given, with reference to the embodiments according to the present invention.

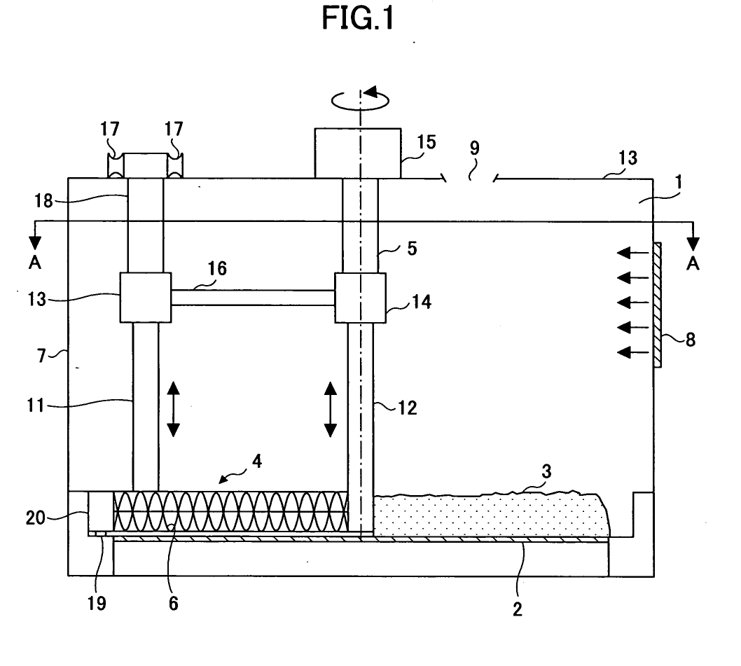

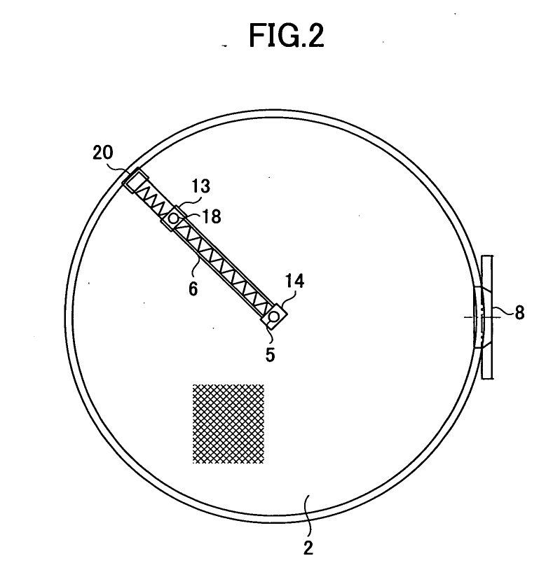

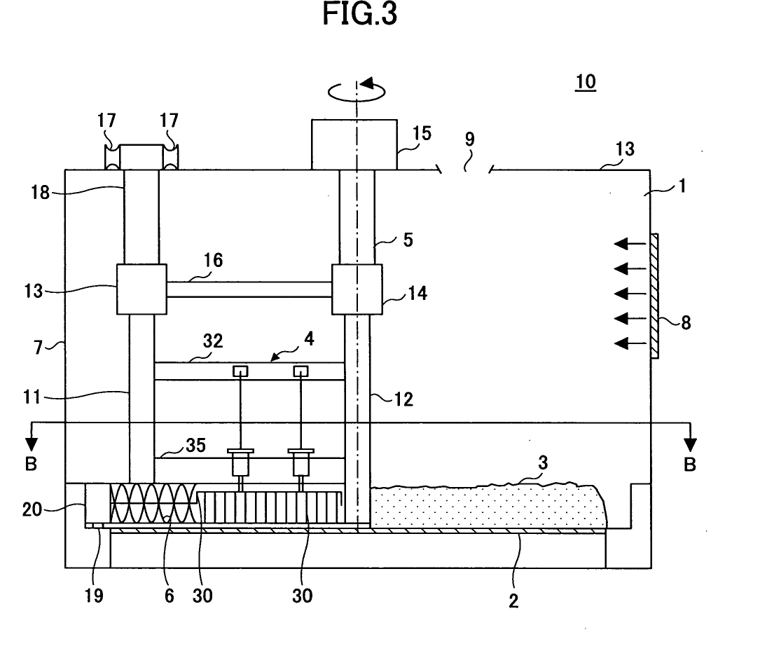

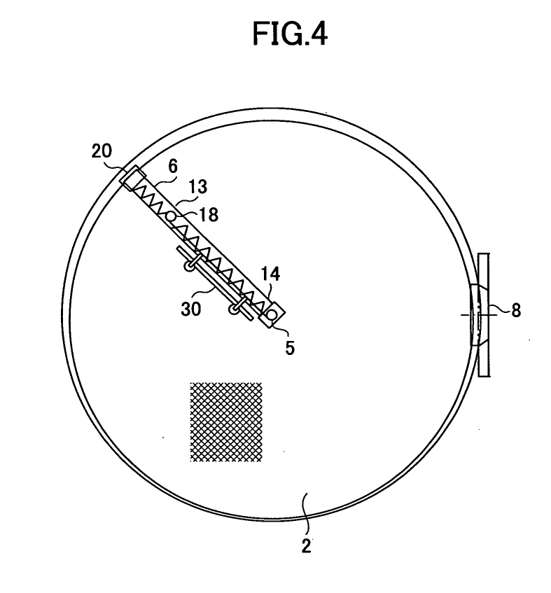

FIGS. 3-5 show one example of the drying apparatus of grain family 10 of the present invention. Basically, the drying apparatus 10 is a structure such that the plow member of the present invention is provided on the apparatus shown in FIGS. 1 and 2. Thus, the same reference numbers are used for the same members as those in FIGS. 1 and 2, and the same explanation is used for these members.

The drying apparatus 10 has the plow member (rake) 30 for plowing a layer of grain family accumulated in front of the screw conveyer 6 comprising the diffusion means 4 provided for rotating around the rotatable shaft 5.

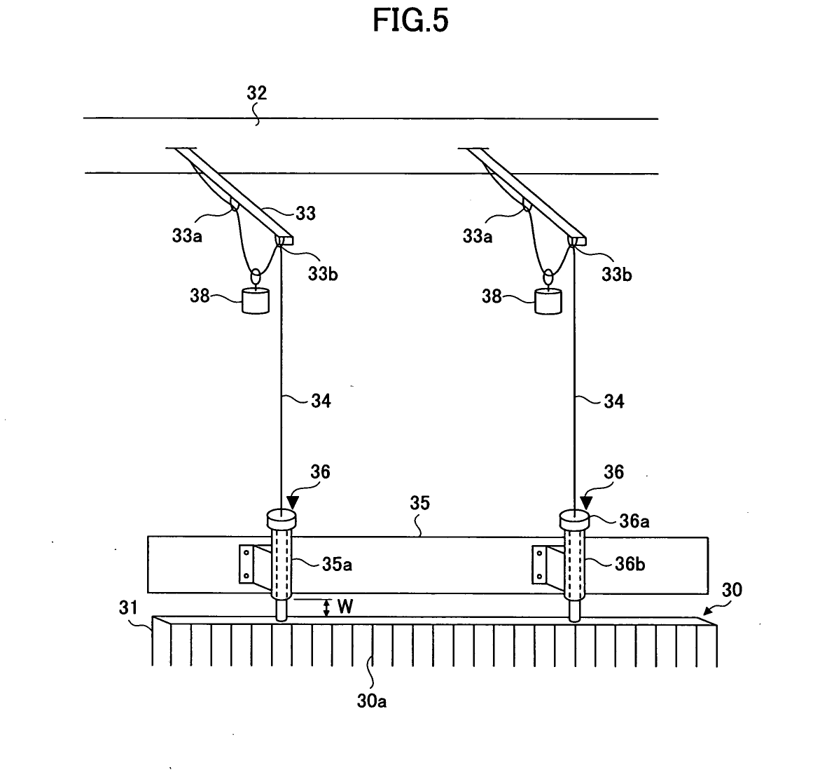

The plow member 30 is provided on the central region in a radial direction along the screw conveyer 6, and is fixed behind and away from the rotational direction of the screw conveyer 6. As shown in FIG. 5, the plow member 30 comprises comb teeth 30a fixed in the metallic angle frame 31 with a comb shape, and the plow member 30 is hung from a support arm 32 fixed in between support shafts 11, 12 with wires 34, and it is thus supported.

As shown in FIG. 5, the wires 34 supports the plow member 30 through two pulley 33a and 33b fixed to support bars 33, 33 fixed to the support arm 32. A crosspiece member 35 in the crosswise direction is installed below the support arm 32 between support shafts 11 and 12, and guide tubes 35a, 35a are fixed to the crosspiece member 35. The wires 34 support the plow member 30 through stoppers 36 attached by the bottom ends of the wires 34. The stoppers 36 each comprises a head 36a and a shaft 36b, and the shaft 36b is inserted into an introducing tube 35a. As shown in FIG. 5 the head 36a of the stopper 36 is abutted with the upper end of the guide tube 35a, and movement to a lower part of the plow member 30 is limited.

On the other hand, a weight 38 is attached between pulleys 33a and 33b of the upper end of the wire 34, so that the depth of the plow member 30 in penetrating the layer of grain family can be adjusted by adjusting with weight of the plow member 30 for a stroke w shown in FIG. 5.

In the below description, grain family is dried by using the drying apparatus 10 of the present invention.

First of all, the grain that should be dried is spent from the inlet 9 in the ceiling 13 of the drying chamber 1 on the floor 2 of the drying chamber 1. In this situation, the grain 3 is in a condition that it is accumulated in the central part of the floor 2 because the inlet 9 is in the vicinity of the center of the drying chamber 1.

Next, the rotation driving device 15 is started to drive, the rotatable shaft is rotated, and the device which drives the screw 20 is started, so that the screw conveyer 6 is driven. The screw conveyer 6 moves the grain in the central part into wall sides of the drying chamber by rotating the screw. Thus, the grain 3 which is spent from the inlet and accumulated in the vicinity of the center of the floor is scattered over the whole floor by rotating the rotatable shaft 5 of the screw conveyer 6 and the rotation of the screw of the screw conveyer 6 so that the grain is scattered and formed into a uniform layer.

As described above, the drying apparatus 10 of the present example has the plow member 30 which disturbs the grain accumulated in the shape of the layer at the central region as well as the diffusion means of the rotatable screw conveyer 6, so that the inside of the layer of the grain which has accumulated in the central region is disturbed and mixed well by the plow member, and the density of the central region where the density tends to rise is lowered and the whole grain layer has a uniform density distribution.

The drying of the grain is performed by blowing the heated wind into the drying chamber from the heat wind blower 8. Since the grain has uniform density over the whole floor, that is, there is no variation of density, the heated wind goes through uniformly in the layer of the grain and the grain is dried uniformly.

The plow member 30 penetrates by its weight in the layer of grain and the plow member rotates around the rotatable shaft 5. However, the depth of the penetration of the plow member 30 is different depending on the kind of grain to be handled. Therefore, the most suitable depth can be obtained depending on the kind of grain by adjusting the weight of the weight 38.

### EXAMPLES

Below, an example in which barley (“Ryouhu” produced in Hokkaido in 2003) was dried by using the drying apparatus of the present example is described. The barley which contains 48% water before introduction to the drying apparatus (Green malt; weight 131 t) was used and the drying process was performed for 17 hours. The targeted degree of dryness was (average water content in malt after finishing drying) 20%.

From the introduction of the green malt into the drying apparatus, the diffusion means of the drying apparatus was operated, and the drying chamber was dried widely. At the same time, the plow means was operated, and disturbed the grain layer at constant depth (about 10 cm), so that the grain layer was equalized.

After finishing equaling the green malt which was to be dried, the heated wind was blown immediately and the drying process was performed.

After finishing drying, about 250 g of grain were gathered every 50 cm where the grain was about 35 cm deep toward the circumference from the floor center of the drying chamber, and the water contents for these samples were measured. The measurement of the water content was performed according to “Moisture content of malt, Section 4 Malt, method 4.2, Analytica-EBC (1998)”.

In order to confirm the effect of the embodiment of the present invention, the same examples were dried using the conventional drying apparatus which does not have the plow means of the present invention, and its result was compared to the result of the example of the present invention.

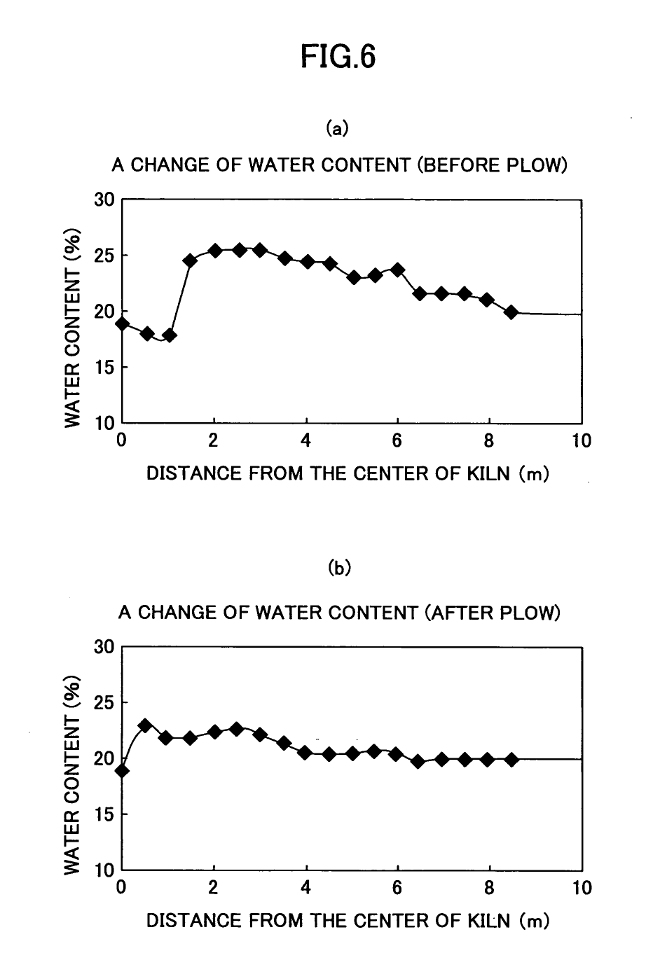

FIG. 6 contains graphs showing results of examples, in which (a) is a graph for using the conventional apparatus without having the plow means; that is before-improvement and (b) is a graph for using the drying apparatus of the present invention.

As shown in FIG. 6(a) before-improvement, there is a region of high water content around 2-4 m from the center. This is caused by the region where existing sedimentation density is high in the vicinity of the center where grain is spent, and it is shown that drying advances toward the wall side.

On the other hand, the whole of the grain layer is a uniform dry state, as shown in FIG. 6(b) of the example of the present invention.

From the above example of the present invention, uniform drying of grain spent in the drying chamber is possible by drying of grain family using the drying apparatus of the present invention; that is, the drying apparatus using the diffusion means provided with the plow means.

The plow means 30 of the drying apparatus 10 of the above example has a length to plow grain in the central region. However, the length of the plow means 30 is not limited to the above example and the length may be extended over the whole radius from the center of the floor.

The present invention is not limited to the specifically disclosed embodiment, and variations and modifications may be made without departing from the scope of the present invention.

The present application is based on Japanese priority application No. 2004-170059 filed on Jun. 8, 2004, the entire contents of which are hereby incorporated by references.

What is claimed is:

1. A drying apparatus of grain family comprising:
a drying chamber having a floor where the circulation of air is possible;
a wind feed means to supply dry wind in the drying chamber;
a feed means to supply the grain family which should be dried in a predetermined position on the floor;
a diffusion means to spread the grain family supplied by the drying chamber in a layer of uniform depth covering the whole floor; and
a plow means which moves with a transfer of the diffusion means and plows the layer of the grain family formed by the diffusion means.

2. The drying apparatus of grain family as claimed in claim 1, wherein at least the plow means is provided to plow the layer of grain family near an inlet position of the grain family for the layer of grain family with a predetermined depth on the floor of the drying chamber by the diffusion means.

3. A drying method of grain family, in which grain family that should be dried is layered with a predetermined depth on a floor of a drying chamber, and the grain or malt is dried by supplying a dry wind and circulating the dry wind in the layer, wherein a density of the layer of grain family is equalized by spreading the grain family on the floor in a layer and also plowing the layer of grain family.

4. The drying method of grain family as claimed in claim 3, wherein the layer of grain family which is formed near an inlet position of the grain or malt which should be dried is plowed to form the layer of grain family on the floor of the drying chamber.
